(19) United States
(12) Patent Application Publication
(10) Pub. No.: US 2005/0120145 A1
(43) Pub. Date: Jun. 2, 2005

(54) Coupling of peripherals to a computer system

(75) Inventors: Michael Andres, Holzgerlingen (DE); Herwig Elfering, Offendorf (FR); Thomas Hess, Bad Liebenzell (DE); Astrid Kreissig, Herrenberg (DE)

Correspondence Address: INTERNATIONAL BUSINESS MACHINES CORPORATION;IP LAW DEPARTMENT, 2455 SOUTH ROAD - MS P386, POUGHKEEPSIE, NY, 12601, US

(73) Assignee: INTERNATIONAL BUSINESS MACHINES CORPORATION, ARMONK, NY (US)

(21) Appl. No.: 10/999,675

(22) Filed: Nov. 30, 2004

(30) Foreign Application Priority Data
Dec. 1, 2003 (DE) 03104470.4

(51) Int. Cl. G06F 13/10

(52) U.S. Cl. 710/8

(57) ABSTRACT

The invention relates to a method of coupling a peripheral to a computer system, with the peripheral having a non-volatile memory for storing data representing information describing the peripheral. The method includes the steps of reading the data from the non-volatile memory by the computer system by means of a predefined communication protocol and instantiating a driver object for the computer system on the basis of this data.

### FIELD OF THE INVENTION

The invention relates to the field of computer systems and the configuration of computer systems in particular to the coupling of peripherals to a computer system or to the coupling of a kind of sensor or actor to a controller.

### BACKGROUND OF THE INVENTION AND PRIOR ART

Computer systems comprise various components such as processing units, memory, a data exchange platform and typically a multiplicity of peripheral devices providing a huge variety of different functionalities. In order to exploit the functional capability of each peripheral device, the operating system of the computer system controlling the interplay between the single components of the computer system must be arranged or customized to the specifications of each peripheral. To provide peripheral specific information required by an operating system in order to exploit the functional capability of the peripheral, a framework based on driver modules has been established. A driver module serves as an interface between a computer system's operating system and a specific peripheral or hardware component.

Typically a driver module only provides specific information about a distinct peripheral. On the one hand a driver module provides parameters as well as peripheral specific commands to the operating system. On the other hand the driver module itself has to be designed to supply a specific operating system. Therefore, for coupling a peripheral to a computer system by means of a driver module, an operating system specific driver must be designed and distributed together with the peripheral.

Operating systems such as Windows™ of Microsoft Corporation comprise a set of standard driver modules for the most common and hence standard peripherals. Coupling one of those standard peripherals to a computer system running this operating system can almost be performed automatically by the operating system.

However, when a new peripheral is released by a hardware supplier, previously released operating systems have to be manually customized to this new peripheral before the peripheral can be used with its entire functionality by such a previously released operating system. The operating system has to be manually updated in order to support the peripheral. Since there exists a huge variety of different operating systems and different versions of operating systems, the peripheral has to be distributed with a whole set of different driver modules, each of which being customized to a distinct operating system.

The support of a huge variety of different versions of an operating system is therefore essential for a peripheral in order to reach an appreciable market share. It is obvious, that a development of such a huge set of driver modules as well as the manual implementation of the driver modules in previously released operating systems is associated with a large expenditure for both the manufacturer of peripherals as well as for the end user. Especially the maintenance of a computer system, i.e. the manual implementation of a driver update, may also be associated with a reboot or a downtime of the computer system causing costs and time.

U.S. Pat. No. 6,449,660 B1 discloses an object-orientated I/O device interface framework mechanism. This I/O interface framework mechanism has objects that represent different I/O devices, objects that represent information about different I/O devices, objects that perform diagnostics on I/O devices, and objects that perform statistical analysis on I/O devices.

The I/O framework mechanism of U.S. Pat. No. 6,449,660 B1 is made up of three interdependent controllers. These controllers are referred to as the hardware resource administrator, the information controller, and the device controller. The hardware resource administrator is responsible for organizing information about I/O devices and for making the organized information available to the other controllers. The information controller is responsible for gathering information about I/O devices and for changing and/or updating certain I/O device information. Accordingly, the information controller is made up of individual objects that each represent the characteristics of a particular I/O device.

This I/O interface framework mechanism has core functions that hide the details of interface hardware, protocols, initialization, and service strategies from the framework consumer in addition to extensible function that allows the consumer to add new I/O devices and make changes to existing I/O devices. Since the device controller is made up of both core and extensible function, parts of the device controller have been designed such that they can be extended and/or customized by the framework consumer, while other parts have been designed such that they are not to be subject to extension or customization by the framework consumer.

According to the disclosure of U.S. Pat. No. 6,449,660 B1, the resource administrator comprises at least one container object, said container object being used to contain at least one information object, said information object being used to represent information about said I/O device. Since the resource administrator is designed to be a core function of the framework mechanism, a representation of information about said I/O device is also a core functionality of the disclosed framework mechanism.

The present invention aims to provide an improved method, a computer system, a peripheral as well as a computer program product for coupling a peripheral to a computer system.

### SUMMARY OF THE INVENTION

The invention provides a method of coupling a peripheral to a computer system by making use of a self-describing functionality. The peripheral comprises a non-volatile memory for storing data representing information of the peripheral which is provided and transmitted to the computer system. In a first step the data stored in the non-volatile memory of the peripheral is read by the computer system, i.e. transferred to the computer system by means of predefined communication protocol.

In a second step the computer system instantiates a driver object on the basis of the received data representing information of the peripheral. Since the peripheral itself provides essential information to the computer system, an appropriate driver object can be instantiated by the computer system or by the operating system in order to provide a complete exploitation of the functional capability of the peripheral. In this way a reconfiguration of the computer system upon embedding of a new peripheral can be performed without explicit user interaction.

On the one hand, the computer system must be arranged in order to read the data from the non-volatile memory of the peripheral as well as instantiating the driver object on the basis of the data. On the other hand, the peripheral has to provide the data representing information of itself to the computer system. Therefore, it must be guaranteed that the computer system as well as the peripheral make use of the same communication platform, which can be realized by a predefined communication protocol.

According to a preferred embodiment of the invention, the instantiated driver object provides access of the peripheral to the computer system. In this way the instantiated driver object of the present invention fulfils the same functionality as a conventional driver module known in the prior art. The driver object acts as an interface between the computer system and the peripheral. In this way the computer system is effectively extended by the functionality of the peripheral.

According to a further preferred embodiment of the invention, the data representing information of the peripheral and being transferred to the computer system is stored at a predefined address and/or predefined path within the non-volatile memory of the peripheral. This predefined address and/or the predefined path must be known to the computer system as well as being accessible by the computer system. The predefined address and/or the predefined path serve as default location of the data that has to be transmitted from the non-volatile memory of the peripheral to the computer system.

When, for example, a new peripheral is connected to the computer system, the computer system first seeks for information about the newly connected peripheral at this predefined location. After retrieving and transmitting a first data packet stored at this predefined location as well as processing of this first data packet, the computer system may seek for further data packets at different locations. In such a case the first data packet must be indicative of locations within the non-volatile memory of the peripheral at which further data packets can be retrieved by the computer system. Retrieving and processing of further data packets may further invoke various operations to be performed by the computer system in order to finally instantiate the driver object.

According to a further preferred embodiment of the invention, the data representing information of the peripheral and being stored in the non-volatile memory of the peripheral is represented in a generic way, allowing for a correct interpretation of the data irrespectively of the type of operating system of the computer system. In this way the method of the present invention is applicable to each computer system supporting the present coupling method no matter on the underlying operating system. In this way a cost and time intensive manual reconfiguration of a computer system due to a coupling of a peripheral becomes dispensable.

Moreover, due to the generic representation of the data stored in the non-volatile memory of the peripheral, a platform independent as well operating system independent coupling can be provided. A generation and development of various driver modules for coupling a single peripheral to a variety of different operating systems becomes redundant.

According to a further preferred embodiment of the invention, the un-instantiated driver module is customized to the specific computer system and/or operating system. The entire functionality of an instantiated driver module is provided by a plurality of driver objects each of which being designed to handle a specific task.

The driver objects in turn are built during the instantiation process of the driver module by making use of an abstract factory pattern in combination with rules stored in the non-volatile memory of the peripheral. The abstract factory patterns are specifically designed for a given computer system or operating system and provide a concrete implementation, as well as instantiation, of the driver objects. The generic rules only provide information referring to the functionality of the abstract factory patterns.

In this way the method makes explicit use of a separation of information which is needed to create a driver module for a specific peripheral to be coupled to a distinct operating system and/or computer system. Information about the functionality of the peripheral is encapsulated by means of rules that are instructive to factory patterns having information about a specific operating system and/or computer system. The combination of rules and factory patterns finally results in the implicit generation of a driver module required by a peripheral in order to interact with a distinct computer system or operating system in an accurate way.

By storing the peripheral specific information in the form of rules in the non-volatile memory of the peripheral and providing essential information of a distinct computer system and/or operating system in the un-instantiated driver module of a computer system by means of factory patterns, provides a platform independent as well as operating system independent approach for universally coupling peripherals to a computer system.

According to a further preferred embodiment of the invention, the data representing information of the peripheral comprises parameters and/or commands being specific for the peripheral and being required for the instantiation of the driver module.

The recitation herein of a list of desirable objects which are met by various embodiments of the present invention is not meant to imply or suggest that any or all of these objects are present as essential features, either individually or collectively, in the most general embodiment of the present invention or in any of its more specific embodiments.

### BRIEF DESCRIPTION OF THE DRAWINGS

The subject matter which is regarded as the invention is particularly pointed out and distinctly claimed in the concluding portion of the specification. The invention, however, both as to organization and method of practice, together with further objects and advantages thereof, may best be understood by reference to the following description taken in connection with the accompanying drawings in which:

FIG. 1 is illustrative of a block diagram of the present invention;

FIG. 2 illustrates a flow chart of the method of the present invention; and

FIG. 3 illustrates a block diagram of a peripheral having a non-volatile memory.

### DETAILED DESCRIPTION OF THE INVENTION

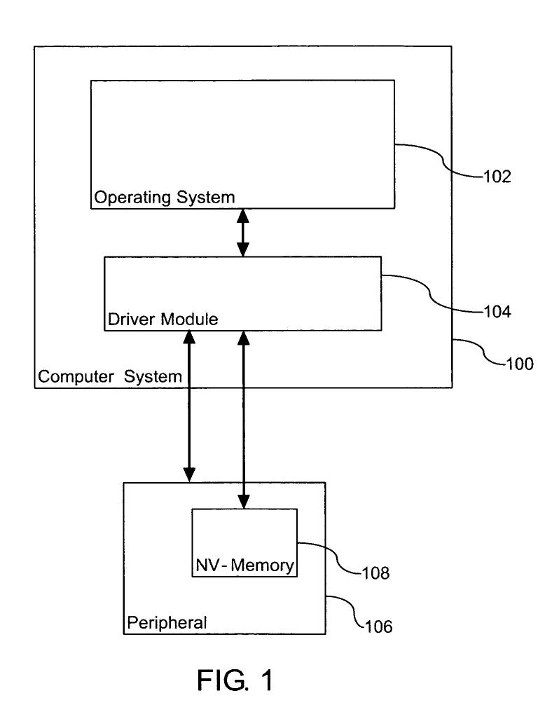

FIG. 1 shows a computer system 100 having an operating system 102 and at least one driver module 104. A peripheral 106 having a non-volatile memory 108 is coupled to the computer system 100 by means of the driver module 104. The driver module 104 serves as an interface between the operating system 102 of the computer system 100 and the peripheral 106. The driver module 104 provides the entire functionality of the peripheral 106 to the operating system 102. It is therefore customized according to the functionality of the peripheral 106.

The driver module 104 acts in a bidirectional way between the operating system 102 and the peripheral 106. On the one hand the driver module 104 provides access of the peripheral 106 to the operating system 102. On the other hand the driver module 104 controls the functionality of the peripheral 106. In this function the driver module 104 transforms commands given by the operating system 102 into a form that can be processed by the peripheral 106.

Before coupling the peripheral 106 to the computer system 100, the driver module 104 is in an un-instantiated state. In order to gain access to a distinct peripheral, a number of driver objects have to be built being specific about the distinct peripheral. The building of driver objects is based on a combination of factory patterns and rules. Whereas the standardized factory patterns are stored in the driver module 104, the rules, being specific of a peripheral, are stored in the non-volatile memory 108 of the peripheral 106. Upon coupling of the peripheral 106 and the computer system 100, the rules stored in the non-volatile memory 108 of the peripheral 106 are transferred to the driver module 104 of the computer system 100. The building of driver objects providing control over the peripheral 106 is performed by means of the operating system 102 and/or by the driver module 104.

After peripheral specific driver objects have been built, interaction between the peripheral 106 and the operating system 102 is handled by the driver module 104.

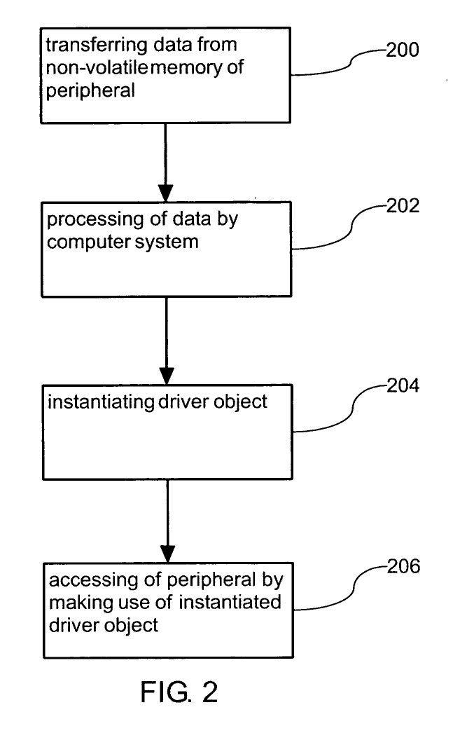

FIG. 2 is illustrative of the coupling process between a peripheral and the computer system. After connection between the peripheral and the computer system is established, the peripheral specific data or rules are transferred from the non-volatile memory of the peripheral to the computer system in step 200. This transfer performed in step 200 may either transfer the entire data or only a first portion of the data stored in the non-volatile memory of the peripheral. In both cases the location of the data must be known to the operating system or to the computer system in a predefined way. Furthermore the transfer of the data must be based on a predefined protocol inherently accessible by the operating system as well as by the peripheral.

In this way at least a first portion of the data has to be transferred either to the operating system and to the un-instantiated driver module of the computer system.

In a next step 202 the first portion of the data or the data in its entirety is processed by the computer system. Processing of the data can be either performed by the un-instantiated driver module or by means of an interplay between the operating system and the driver module. In a next step 204 the peripheral specific driver objects are instantiated leading to a complete instantiation of the driver module.

After this instantiation, the driver module has been completely built and hence providing access to the complete functionality of the peripheral in step 206. Step 206 represents the final state of the coupling process in which the entire functionality of the peripheral is accessible by the operating system via the driver module.

The above described coupling process can be modified according to a multiplicity of different ways. The method of the coupling process requires a utilization of a predefined communication protocol only for the first data portion. After transmittance of this first data portion, the processing of said data portion can take place before further data is transferred between the peripheral and the computer system. In response to the processing of said first data portion the method of coupling the peripheral to the computer system can be modified according to a multiplicity of different ways.

For example the process can switch to a different communication protocol, which means that the transfer of successive data portions from the non-volatile memory of the peripheral to the computer system is based on a different communication protocol, which in turn must be supported by both the peripheral as well as by the computer system.

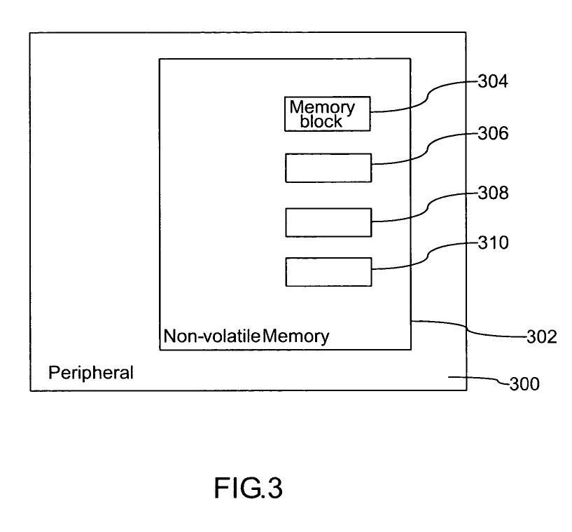

FIG. 3 shows a block diagram of the peripheral 300 having a non-volatile memory 302. The non-volatile memory comprises different memory blocks 304, 306, 308 and 310. The memory blocks 304 . . . 310 are specified by a unique address within the non-volatile memory 302. Especially the address of the first memory block 304 must be standardized in the sense that it is known to any computer system supporting the coupling method described in the present invention.

When the peripheral 300 is connected to a computer system, the computer system first has to extract the data located in the first memory block 304. After processing of this first data portion by the computer system, various different actions for an instantiation of the peripheral may take place.

In this way the present invention provides an improved method of coupling a peripheral to a computer system by means of a self-describing functionality of the peripheral. Peripheral specific information is stored in the peripheral itself and provided to the computer system upon establishing a connection between a peripheral and computer system. A required instantiation of a driver module giving full access to the peripheral is then performed by the computer system and/or the operating system of the computer system. In this way no additional information of the peripheral must be supplied manually to the computer system. Furthermore the method allows a platform independent as well as operating system independent and hence a universally applicable coupling procedure.

### List of Reference Numerals

| | |
|---|---|
| 100 | Computer system |
| 102 | Operating system |
| 104 | Driver module |
| 106 | Peripheral |
| 108 | Non-volatile Memory |
| 300 | Peripheral |
| 302 | Non-volatile Memory |
| 304 | Memory block |
| 306 | Memory block |
| 308 | Memory block |
| 310 | Memory block |

While the invention has been described in detail herein in accord with certain preferred embodiments thereof, many modifications and changes therein may be effected by those skilled in the art. Accordingly, it is intended by the appended claims to cover all such modifications and changes as fall within the true spirit and scope of the invention.

1. A method of coupling a peripheral to a computer system, the peripheral having a non-volatile memory for storing data representing information of the peripheral, the method comprising the steps of:
reading the data from the non-volatile memory by the computer system by means of a predefined communication protocol; and
instantiating a driver object by the computer system on the basis of the data.

2. The method according to claim 1, wherein the instantiated driver object provides access for the peripheral to the computer system.

3. The method according to claim 1, wherein the data is stored at a predefined address and/or on a predefined path within the non-volatile memory of the peripheral.

4. The method according to claim 1, wherein the data is represented in a generic way independent of an operating system of the computer system.

5. The method according to claim 1, wherein the data comprises parameters and/or commands specific to the peripheral and required for the instantiation of the driver object.

6. A method for use in a computer system for coupling a peripheral, the peripheral having a non-volatile memory for storing data representing information of the peripheral, the computer system being adapted to perform the steps of:
reading the data from the non-volatile memory by the computer system by means of a predefined communication protocol; and
instantiating a driver object of the computer system on the basis of the data.

7. The computer system according to claim 6, wherein the instantiated driver object provides access for the peripheral to the computer system.

8. The computer system according to claim 6, wherein the data is stored at a predefined address and/or on a predefined path within the non-volatile memory of the peripheral.

9. The computer system according to claim 6, wherein the data is represented in a generic way independent of an operating system of the computer system.

10. The computer system according to claim 6, wherein the data comprises parameters and/or commands specific to the peripheral and required for the instantiation of the driver object.

11. A peripheral for coupling to a computer system, the peripheral comprising:
a non-volatile memory for storing data representing information of the peripheral;
means for providing the data to the computer system by making use of a predefined communication protocol; and
means for instantiating a driver object of the computer system on the basis of the data.

12. The peripheral according to claim 11, wherein the instantiated driver object provides access for the peripheral to the computer system.

13. The peripheral according to claim 11, wherein the data is stored at a predefined address and/or on a predefined path within the non-volatile memory of the peripheral.

14. The peripheral according to claim 11, wherein the data is represented in a generic way independent of an operating system of the computer system.

15. The peripheral according to claim 11, wherein the data comprises parameters and/or commands specific to the peripheral and required for the instantiation of the driver object.

16. A computer program product for coupling a peripheral to a computer system, the peripheral having a non-volatile memory for storing data representing information of the peripheral, the computer program product comprising program means for performing the steps of:
reading the data from the non-volatile memory by the computer system by means of a predefined communication protocol; and
instantiating a driver object of the computer system on the basis of the data.

17. The computer program product according to claim 16, wherein the program means is adapted to provide access for the peripheral to the computer system by means of the instantiated driver object.

18. The computer program product according to claim 16, wherein the program means is adapted to store the data at a predefined address and/or one predefined path within the non-volatile memory of the peripheral.

19. The computer program product according to claim 16, wherein the program means is adapted to represent the data in a generic way independent of the operating system of the computer system.

20. The computer program product according to claim 16, wherein the program means is adapted to process the data comprising parameters and/or commands specific to the peripheral and being required for the instantiation of the driver object.
